(19) United States
(12) Patent Application Publication
(10) Pub. No.: US 2005/0239450 A1
(43) Pub. Date: Oct. 27, 2005

(54) System and method for a secure programmable communicator

(76) Inventor: Philip Bernard Wesby, Tiddington (GB)

Correspondence Address: BROMBERG & SUNSTEIN LLP, 125 SUMMER STREET, BOSTON, MA, 02110-1618, US

(21) Appl. No.: 11/130,024

(22) Filed: May 16, 2005

Related U.S. Application Data
(63) Continuation of application No. 10/523,740.

(30) Foreign Application Priority Data
Aug. 6, 2002 (GB) 0218221.0

(51) Int. Cl. H04M 3/00; H04Q 7/20

(52) U.S. Cl. 455/418; 455/550.1

(57) ABSTRACT

A system and method for a secure programmable communicator is described which can provide the basis for an improved child communicator, an improved sports person communicator, as well as providing a telecommunications capability to a games console plug-in. In one embodiment, the secure programmable communicator platform is integrated with an enclosing structure comprising a movable arm to embody the essential design of a climber's carabiner safety clip making possible that the device can be securely locked to an article of clothing, or to a rucksack, or to a rigid structure such as a bicycle, or to inventory casing. In different embodiments, the platform comprises a display and a memory containing a library of emoticon image elements, which can be exchanged by telecommunications messages and or by infrared light thereby providing the means to personalise the display and to share emoticons with similar devices.

### CROSS-REFERENCE TO RELATED APPLICATIONS

This application is a continuation of U.S. patent application Ser. No. 10/523,740, entitled “System and Method for Activation of a Secure Programmable Communication Device,” filed Feb. 4, 2005, which is the National Stage of International Application No. PCT/GB2003/003423, entitled “System and Method for Activation of a Secure Programmable Communication Device,” filed Aug. 6, 2003, which claims priority from GB Patent Application Serial No. 0218221.0 filed Aug. 6, 2002, all of which applications are hereby incorporated by reference in their entireties.

### TECHNICAL FIELD AND BACKGROUND OF THE INVENTION

The invention relates to a system and method for a secure programmable communicator. More particularly, it relates to a system and method for a new and improved wireless communications platform enclosure, which enables a communications means to be securely attached to an article of clothing, or to a rucksack, or to a rigid structure such as bicycle or inventory casing, as well as providing a plug-in telecommunications capability to a games console.

In one embodiment, the said system and method for a secure programmable communicator comprises an enclosing structure with a movable arm, which can open and lock closed around a device to which it is to be securely attached such that it embodies the essential design of a climber's carabiner safety clip. The locking mechanism of the clip is fully integrated with the electronic control circuitry of the wireless platform and may be mechanically or electromechanically controlled. Encoded mobile telecommunications messages may be used to securely lock the carabiner clip locking-arm such that only authenticated messages from authorised persons may enable the clip to be unlocked. In a locked state, the integrity of the locking mechanism is supervised by a processing function running on the wireless platform, such that any unauthorised opening of the clip is immediately reported to a remote fixed or wireless device and an alarm may be triggered.

In different embodiments, the platform comprises a display and a memory containing a library of emoticon image elements, which can be exchanged by telecommunications messages and or by infrared light thereby providing the means to personalise the display and to share emoticons with similar devices.

The invention relates to and significantly improves upon certain features of two previously filed patent applications claiming Finnish priority, namely the application filed on Sep. 9, 1997 entitled Emergency Mobile Radio Telephone with Reduced Key Set, published as international patent application WO 99/13629 A2, and the application filed on May 23, 2000 entitled Programmable Communicator published as international patent application WO 01/91428 A2.

In the application entitled Emergency Mobile Radio Telephone with Reduced Key Set, published as WO 99/13629 A2, is taught the invention of using a mobile phone comprising a programmable identity module such as a SIM card, in the context of the GSM telecommunications standard, to program remotely the number of any mobile or fixed telephone to which the communicator, comprising the same type of programmable identity module, is to be linked.

The current invention builds upon the teaching of this earlier application and extends the concept significantly to incorporate an innovative means to attach the reduced key set communication device to a rucksack, to an article of clothing, or to a games console. In addition, the invention teaches a new way of activating the device, linking the billing of the device to an existing mobile phone subscription.

In the application entitled Programmable Communicator, published as WO 01/91428 A2, is taught the invention of an improved wireless telecommunications platform for remote monitoring purposes which can be programmed remotely by a mobile phone or any type of Personal Data Assistant, either at close range using Blue Tooth, or infra red light, or via a mobile telecommunications network connection.

The current invention builds upon the teaching of this earlier application and extends the concept significantly to incorporate an innovative means to attach a wireless device securely to a rigid or flexible structure.

Today, the mobile telecommunications industry is making a transition towards high bandwidth high capacity 3^{rd} Generation wireless networks. The associated costs of the 3^{rd} Generation wireless network infrastructure and the lack of market drivers are challenging the growth of the mobile industry. Clearly, a diverse range of mobile services is required which can offer a high growth of subscription contracts and which can also run efficiently and effectively on today's 2^{nd} Generation telecommunications infrastructure. The system and method according to the present invention is directed towards this requirement area.

The mobile phone industry is driven by brand image and fashion, yet the industry lacks a stylish design for a mobile phone, which is convenient and attractive for younger persons to use. The current invention is particularly directed towards creating a mobile communicator in the form of a sports icon as well as providing a rugged protection case for the device. In addition, in a separate embodiment, the current invention addresses the fashion issue and sports applications arena through the teaching of a means to attach the communications platform as a module directly to fabric for sports applications and recreational clubbing, where a mobile phone is desired, but as a separate item, it is inconvenient to carry.

In other areas, it is beneficial to attach a wireless platform securely to an existing structure such as a utility meter, or to the frame of a bicycle. The current invention is also particularly directed to address this requirement. In general, wherever there is a need to attach a wireless platform such as for remote tracking of inventory, it is beneficial if the said platform possesses the capability for locking it securely to the external casing surrounding the inventory, or to a prepared attachment mount, which is integral with the outer surface of the external casing.

In the application area of rail freight and road freight transportation, there exists the need for an electronic wireless device, which may use any form of wireless communication means, and which comprises extended battery duty cycle capability, which may be attached securely to a container enclosing perishable produce such that it provides a safe and secure means for monitoring the location and or state of the produce such as the internal temperature of the container.

In the area of child security and in order to provide a simple and secure means of communication for children, a solution is needed to provide a system and method to enable a child communicator device to register itself automatically to an existing mobile phone subscription. Such a solution would enable off-the-shelf purchases of a child communicator to be made in high street shops and provide immediate plug-and-play capability by bringing the device on-line within an active mobile phone subscription. Such a capability would drive increased mobile phone subscriptions.

In the application areas outlined above, such as for attaching a wireless communications module to an article of clothing, or to a device to be monitored, an improved rugged design is required which both protects the cell phone engine and battery and which looks stylish. For example, in the application area of youth security, children are often reluctant to wear the device unless its shape and form has a positive association with an icon of fashion or an extreme sport such as mountaineering. The shape and form of the wireless module is designed to address this image aspect directly.

In the separate application area of electronic games such as the Nintendo Gameboy which comprises the capability for accepting games in the form of a plug-in module, such game consoles could be improved if they could comprise a wireless telecommunications capability and a GPS capability either securely locked to the console or made in the same shape and form as the plug-in games module. In this way the console would become capable of communicating via voice and or data with one or more similar devices and provide the basis for location dependent game creations.

Further to these limitations of existing technologies, and so far as is known, no system and method for a secure programmable communicator is presently available which is directed towards the specific needs of this problem area as outlined.

Accordingly, it is an object of the present invention to provide an improved secure wireless communications platform, which comprises the means to attach itself securely to an article of clothing, or to a rucksack, or to a fixed structure such as to the frame of a bicycle or to an inventory casing.

It is a further object of the present invention to provide an improved secure wireless communications platform, which in one embodiment comprises an enclosing structure with a movable arm, which can open and lock closed around a device to which it is to be securely attached.

It is a further object of the present invention to provide an improved secure wireless communications platform, which in one embodiment comprises an enclosing structure with a movable arm such that the enclosing structure comprises an empty void around which the arm closes.

It is a further object of the present invention to provide an improved secure wireless communications platform, which in one embodiment comprises an enclosing structure with a movable arm, which can open and lock closed around a device to which it is to be securely attached wherein the enclosing structure further comprises a compartment to enclose the said wireless communications platform.

It is a further object of the present invention to provide an improved secure wireless communications platform, which in one embodiment comprises an enclosing structure with a movable arm, which can open and lock closed around a device to which it is to be securely attached wherein the enclosing structure further comprises the battery for the wireless communications platform.

It is a further object of the present invention to provide an improved secure wireless communications platform, which comprises an enclosing structure with a movable arm, which can open and lock closed around a device to which it is to be securely attached such that in one embodiment it essentially comprises the shape and form of a climber's carabiner safety clip.

It is a further object of the present invention to provide an improved secure wireless communications platform, which comprises an enclosing structure moulded in the form of a movable clamp, which can open and lock closed around a device to which it is to be securely attached such that in one embodiment it essentially comprises the shape and form of a bulldog clip.

It is a further object of the present invention to provide an improved secure wireless communications platform, which in one embodiment comprises an enclosing structure with a movable arm, which can open and lock closed around a device to which it is to be securely attached wherein the closing mechanism is fully integrated with the wireless platform such that a processing function running on the platform supervises the status of the locking mechanism.

It is a further object of the present invention to provide an improved secure wireless communications platform, which in one embodiment comprises an enclosing structure with a movable arm, which can open and lock closed around a device to which it is to be securely attached wherein the closing mechanism is fully integrated with the wireless platform such that the status of the moveable arm can be remotely interrogated by a telecommunications message such as SMS, MMS or EMS.

It is a further object of the present invention to provide an improved secure wireless communications platform, which in one embodiment comprises an enclosing structure with a movable arm, which can open and lock closed around a device to which it is to be securely attached wherein the closing mechanism is fully integrated with the wireless platform such that encoded mobile telecommunications messages may be used to securely lock the arm such that only authenticated messages from authorised persons enable the arm to be unlocked.

It is a further object of the present invention to provide an improved secure wireless communications platform, which in one embodiment comprises an enclosing structure with a movable arm, which can open and lock closed around a device to which it is to be securely attached wherein the closing mechanism is fully integrated with the wireless platform such that the status of the moveable arm can be reported back in the form of a telecommunications message such as via SMS, MMS or EMS, either in response to a request or automatically in response to an alarm condition.

It is a further object of the present invention to provide an improved secure wireless communications platform, which in one embodiment comprises an enclosing structure with a movable arm, such that the wireless platform comprises a removable wireless module and battery wherein each is integrated by way of the processing function with the enclosing structure and the status of the moveable arm such that the wireless module and or battery may not be removed unless the said arm is unlocked.

It is a further object of the present invention to provide an improved secure wireless communications platform, which in one embodiment comprises an enclosing structure with a movable arm wherein, the locking mechanism is electromechanical.

It is a further object of the present invention to provide an improved secure wireless communications platform, which in one embodiment comprises an enclosing structure with a movable arm wherein, the locking mechanism is mechanical.

It is a further object of the present invention to provide an improved secure wireless communications platform, which in one embodiment comprises an enclosing structure with a movable arm, such that the locking mechanism may comprise an additional mechanical barrel lock of rotary wheels, each bearing the integers 1 to 9, such that only the correct alignment of numbers will enable the barrel lock to open.

It is a further object of the present invention to provide an improved secure wireless communications platform which may make use of a wireless platform operating according to any of the mobile telecommunications standards such as GSM, GPRS, CDMA, WCDMA, PHS, PDS, wherein the said platform comprises a loudspeaker and microphone or a port for an audio-voice headset and or a GPS module

It is a further object of the present invention to provide an improved secure wireless communications platform, which comprises either a single call button, or two call buttons, each of which protrude within the void enclosed by the arm such that each is protected from damage.

It is a further object of the present invention to provide an improved secure wireless communications platform, which in one embodiment comprises an LCD display and or light emitting fibre display and or a light emitting polymer display on its outer surface with a button at either end of the screen such that incoming messages are shown in the display and, for calling purposes, a different caller's number can be displayed and scrolled backwards and forwards by pressing either of the two buttons respectively to access the said numbers from a stored memory wherein, the display shows the current number which will be called when the call button is pressed.

It is a further object of the present invention to provide an improved secure wireless communications platform, which in one embodiment comprises an LCD display and or a light emitting fibre display and or a light emitting polymer display on its outer surface such that personalised stationary and or animated emoticon images can be displayed.

It is a further object of the present invention to provide an improved secure wireless communications platform, which in one embodiment comprises an LCD display and or a light emitting fibre display and or a light emitting polymer display on its outer surface and has stored in an internal memory a number of animated or stationary emoticon images, wherein each image comprises an associated code such that each stored emoticon image can be selected and displayed by selecting the coded number.

It is a further object of the present invention to provide an improved secure wireless communications platform, which in one embodiment comprises an LCD display and or a light emitting fibre display and or a light emitting polymer display on its outer surface and has stored in an internal memory a library of animated or stationary emoticon images, wherein each image comprises an associated code such that one or more of the emoticon images are displayed when the said communications platform receives an SMS, MMS or EMS type message comprising one or more of the said codes.

It is a further object of the present invention to provide an improved secure wireless communications platform, which in one embodiment comprises an input/output port, and has stored in an internal memory a library of animated or stationary emoticon images, wherein different libraries of image elements can be downloaded from Internet web pages to the communicator platform by way of the said input/output port.

It is a further object of the present invention to provide an improved secure wireless communications platform, which in one embodiment comprises an input/output port, and has stored in an internal memory a library of animated or stationary emoticon image elements, wherein different libraries of image elements can be sent to the wireless platform by sending an SMS, MMS or EMS type message.

It is a further object of the present invention to provide an improved secure wireless communications platform, which in one embodiment comprises an input/output port, and has stored in an internal memory a library of animated or stationary emoticon image elements, wherein a different library or subset of image elements can be sent to the wireless platform by sending the Internet web address of the location where the library of emoticon images are stored and cause the platform to download and display the said image elements.

It is a further object of the present invention to provide an improved secure wireless communications platform, which in one embodiment comprises an internal memory storing a library of animated or stationary emoticon image elements, and a set of display commands which actively control the movement, colour, hue, size, screen location, and such like characteristics of each emoticon element, wherein the display of the platform can be personalised in exciting ways.

It is a further object of the present invention to provide an improved secure wireless communications platform, which in one embodiment comprises an internal memory storing a library of animated and or stationary emoticon image elements, and a set of display commands which actively control the movement, colour, hue, size, screen location, and such like characteristics of each emoticon element, wherein the display can be user-programmed to show rapidly moving bands of changing colour and of changing shape and or alphanumeric characters.

It is a further object of the present invention to provide an improved secure wireless communications platform, which in one embodiment comprises an LCD display and or a light emitting fibre display and or a light emitting polymer display on its outer surface and an input/output port, and has stored in an internal memory a library of animated or stationary emoticon image elements, and a set of display commands which actively control the movement, colour, hue, size, screen location, and such like characteristics of each emoticon element, wherein incoming calls can be linked to the display of emoticon elements and commands to cause images to be generated on the display.

It is a further object of the present invention to provide an improved secure wireless communications platform, which in one embodiment comprises an infrared communications port such that information, which controls the emoticon image elements can be received by the said infrared port and thereby cause the emoticon image shown on the display of the platform to change.

It is a further object of the present invention to provide an improved secure wireless communications platform, which in one embodiment comprises an infrared communications port such that information which controls the emoticon image elements can be sent by the platform to a second platform and thereby cause the emoticon image shown on the display of the second platform to change.

It is a further object of the present invention to provide an improved secure wireless communications platform, which in one embodiment comprises a separate wrist-worn infrared control module, wherein a push button display on the said control module communicates commands to the platform via infrared light such that the platform can be caused to communicate with another platform via infrared light, or send a telecommunications message, or make a call to a selected number shown in the display of the wrist-worn control module.

It is a further object of the present invention to provide an improved secure wireless communicator, which in different embodiments may comprise two moveable interlocking arms, integrated with the structure of the wireless communicator, which open and close together around a void enclosed by the arms to enable a flexible means of connecting the secure communicator to a rigid object such as a bicycle frame.

It is a further object of the present invention to provide an improved secure wireless communicator, which in different embodiments may comprise one or more moveable clips, integrated with the structure of the wireless communicator, which open and close around a raised rigid or flexible element, wherein said raised element forms part of a surface of a casing or article of clothing or device to which the communicator is to be attached.

It is a further object of the present invention to provide an improved secure wireless communicator, which in different embodiments may be locked securely to a raised rigid or flexible element, wherein said rigid or flexible element is attached to fabric or plastic or metal by means of a chemical bonding agent.

It is a further object of the present invention to provide an improved secure wireless communicator, which in different embodiments may be locked securely to a raised rigid or flexible element, wherein said rigid or flexible element is attached to fabric or plastic by means of a backing plate comprising one or more protruding pins which pass through the back surface of the said fabric or plastic or metal and lock securely to the reverse side of the said raised rigid or flexible element, thereby integrating the backing plate with the said rigid or flexible element.

It is a further object of the present invention to provide an improved secure wireless communicator, which in different embodiments may be locked securely to a raised rigid or flexible element, wherein said rigid or flexible element is attached to fabric or plastic by means of a backing plate comprising one or more magnets which attract magnetic surfaces of opposite polarity through the back surface of the said fabric or plastic and lock securely to the reverse side of the said raised rigid or flexible element, thereby integrating the backing plate with the said rigid or flexible element.

It is a further object of the present invention to provide an improved secure wireless communicator, which in different embodiments may comprise three or more interlocking arms, integrated with the structure of the wireless communicator, which open and close together around a void enclosed by the arms to enable a flexible means of connecting the secure communicator to a rigid object.

It is a further object of the present invention to provide an improved secure wireless communicator, which in different embodiments comprises one or more light-emitting diodes and or light emitting fibres and or light emitting polymers on its outer surface, which can emit light of different colours and in different pulse sequences according to the current status of the secure communicator such as the status of idle mode, active mode, mobile cell field strength coverage level, battery charge level and such like.

It is a further object of the present invention to provide an improved secure programmable communicator having direct application to hikers and mountaineers or skiers in difficulty wherein each such person has a smart clothes user-programmable communications tag which comprises the means to attach itself to their clothing, which is pre-programmed to be linked with a fixed or mobile telephone wherein it comprises a single call button for communication with a central alarm point and has the capability to establish voice communication and or transfer data messages comprising a current GPS coordinate and or a voicemail message to a destination subscriber number of a fixed or mobile phone or to an IP address.

It is a further object of the present invention to provide an improved secure programmable communicator, which in one embodiment comprises the means to lock itself securely to an electronics games console and be integrated with the said console such that it can extend the capability of the games console by adding a wireless telecommunications and or a GPS capability, which can form the basis of a new game concept, wherein the secure programmable communicator may also be designed to slot into an existing port in the console.

It is a further object of the present invention to provide an improved secure programmable communicator, which in one embodiment comprises the means to lock itself securely to an electronics games console which accepts plug-in games modules, wherein the said communicator may partially or completely comprise the shape of one of the plug-in games modules and form the basis of a new game concept.

It is a further object of the present invention to provide an improved secure programmable communicator, which in one embodiment comprises an integral part of a portable games console such that it provides the basis for a game based upon exchanging GPS locations with other players in the game, wherein if one player correctly predicts the GPS position of another player at a future time within a given resolution, that other player is removed from the game.

It is a further object of the present invention to provide a system and method for an improved secure programmable communicator which enables the communicator device to register itself automatically to an existing mobile phone subscription using messages sent from the mobile phone associated with said subscription.

Other objects and advantages of this invention will become apparent from the description to follow when read in conjunction with the accompanying drawings.

### BRIEF SUMMARY OF THE INVENTION

Certain of the foregoing and related objects are readily attained according to the present invention by the provision of a novel secure programmable communicator system and method, which in different embodiments serves to address the diverse requirements of attaching a wireless communications device and or positioning device to clothing or to sports equipment or to a rigid structure such as a bicycle or freight container, or to a games console, as well as providing the means to activate the device and charge it to an existing mobile phone subscription.

The secure programmable communicator comprises a wireless platform contained within a secure housing comprising one or more moveable arms or securing elements, which lock together around an object, or raised surface element, to which the communicator is to be attached. In different embodiments the platform may comprise a processing function, which continuously supervises the integrity of the locking mechanism.

For child and sports applications, in one embodiment the secure programmable communicator may essentially comprise the form of a climber's carabiner safety clip, which may easily be attached to equipment such as a rucksack or a bicycle frame.

For phone to fabric applications and for inventory tagging, the secure programmable communicator may integrate with a rigid or flexible surface element, which is attached to the fabric or forms part of the inventory casing. In different embodiments, the rigid or flexible surface element may be chemically bonded directly to the fabric or casing, or it may be attached to a backing plate which sandwiches the fabric between the said plate and said surface element using pins, or magnets or such like. In other phone to fabric embodiments, the said backing plate may use magnets or interlocking pins and integrate directly with the back surface of the said communicator structure thereby sandwiching the fabric directly between the backing plate and the communicator itself.

For games console applications, the secure programmable communicator can be moulded to integrate with the console games-module input port and communicate with the games console operating system and thereby bring a telecommunications and GPS capability together with locked-down calling functionality to the games console. In addition, new and exciting games can be developed for the games console, which combine remote GPS coordinates and telecommunications capability.

In different embodiments, the secure programmable communicator platform may comprise an LCD or light emitting fibre or light emitting polymer display and comprise a memory module to store a library of emoticon image elements and commands such that user-programmable emoticons can be created on the device. Telecommunications messages and or an infrared input/output port can be used to transmit and receive emoticon image elements and commands to and from other similar devices, which can cause the emoticon images to change accordingly.

In one embodiment, the phone-to fabric communicator may be controlled by a wrist-worn control panel, which comprises a keypad and display to select phone numbers or to write messages or to select emoticon image elements, wherein the wrist-worn control panel communicates with the communicator using infrared light such that it may control the emoticon display and send and receive messages and make and receive calls.

Other objects and features of the present invention will become apparent from the following detailed description considered in connection with the accompanying drawings, which disclose several embodiments of the invention. It is to be understood, however, that the drawings are designed for the purpose of illustration only and that the particular description of the chosen applications of the secure programmable system and method are given by way of example only and do not limit the scope of the invention.

### BRIEF DESCRIPTION OF THE DRAWINGS

The foregoing features of the invention will be more readily understood by reference to the following detailed description, taken with reference to the accompanying drawings, in which:

FIG. 1 illustrates an image of the child communicator and sports person communicator according to the present invention;

FIG. 2 illustrates a schema showing one embodiment of the components of the secure programmable communicator platform;

FIG. 3 illustrates an alternate image of the child communicator and sports person communicator according to the present invention;

FIG. 4 illustrates an alternate image of the child communicator and sports person communicator according to the present invention;

FIG. 5 illustrates a schematic of one method to activate the secure programmable communicator and to register it automatically to an existing mobile phone subscription according to the present invention;

FIG. 6 illustrates a games console integrated with a plug-in secure programmable communicator platform; and

FIG. 7 illustrates an image of a different embodiment of the secure programmable communicator platform integrated with a backing plate for attachment to clothing.

### DETAILED DESCRIPTION OF THE INVENTION

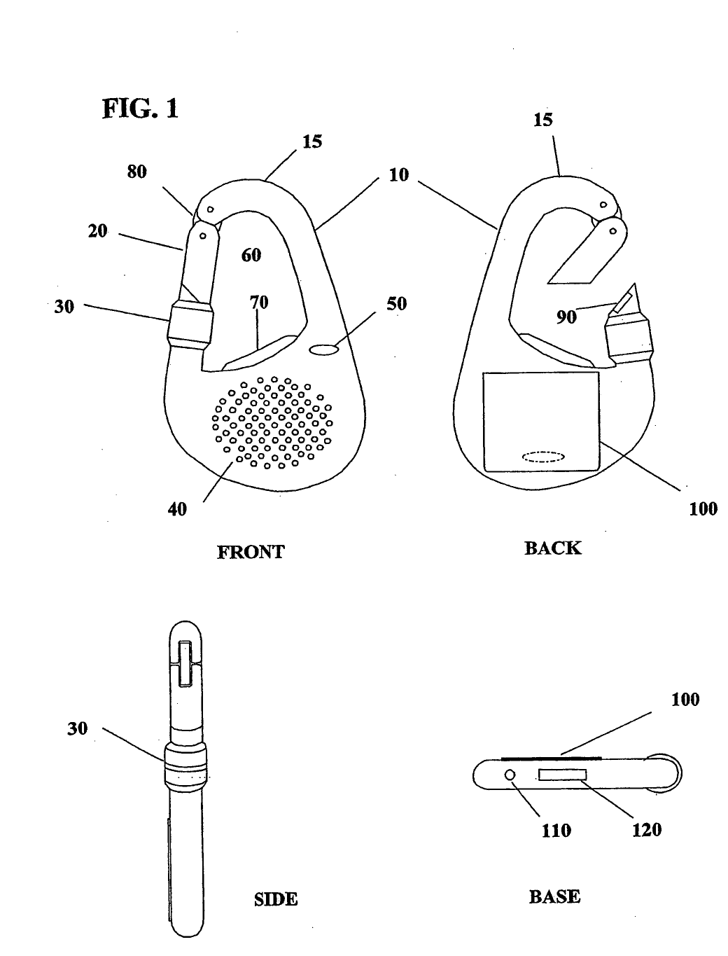

Referring now in detail to the drawings and in particular to FIG. 1 thereof, therein illustrated are four images of the external form of the secure programmable communicator according to one embodiment of the present invention.

The following description makes reference to the detailed features and applications as outlined in the objects of the invention.

In the embodiment shown, the programmable secure communicator (10) comprising a wireless telecommunications platform, is designed in the form of a climber's carabiner safety clip such that it can provide a secure means of attaching a telecommunications device to a rucksack or bicycle frame and comprise a fashionable shape such as that of an extreme sports icon. In this way a child would be willing and eager to wear such a device.

The secure programmable communicator (10) comprises an extended fixed arm (15) and a moveable arm (20), which can move inwards, as shown, around an axis joint (80). The axis joint (80) may be spring-loaded, to ensure that the moveable arm (20) is closed in the rest position. A secure locking mechanism (30) comprising a rotating sleeve can move up or down according to the direction that the sleeve is rotated. When the sleeve is rotated and moved down, the locking arm (20) can move out of the closed position and into the void (60) that is enclosed by the fixed arm (15) and the moveable arm (20).

A speakerphone (40) provides basic voice and audio communication. An LED display (50) comprising different colours can indicate the status of the device such as active mode, idle mode, out of base-station coverage area, and such like. A call button (70) protrudes into the void (60) enclosed by the fixed arm (15) and the moveable arm (20). The call button may be used to phone a number or to answer an incoming call.

The moveable arm (20) makes contact with a sensing element (90), which is supervised by a processing function running on the wireless telecommunications such that the locking mechanism (30) can be enabled or disabled by the processing function. The processing function can itself in turn be controlled by telecommunications messages.

The battery for the device is contained behind a panel (100). At the base of the device are shown a battery recharge port (110) and a telecommunications port (120) for connecting a separate audio headset and or for connecting the device to a computer for optionally changing the subscriber numbers to which the secure communicator can call or be allowed to receive calls from.

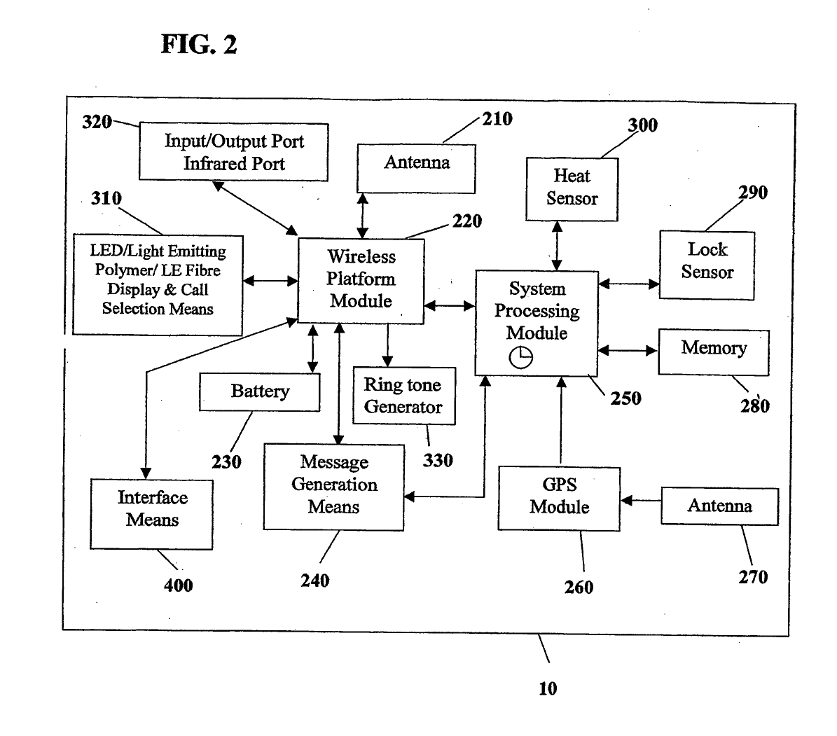

With reference now to FIG. 2, the schematic shows the functional elements of the secure programmable communicator (10). Incoming telecommunications messages and phone calls are received by the antenna (210) and processed by the wireless platform module (220). The wireless platform module (220) is linked to a system-processing module (250), which receives data from a heat sensor (300), a lock sensor (290), and the GPS module (260). The GPS module comprises a standard baseband correlator and processes GPS positional coordinates from data received via the antenna (270).

A memory module (280) stores processed information and previously calculated GPS coordinates with reference to real-time clock data generated by the system-processing module (250).

Telecommunications messages can be generated by a message generation means (240), which may receive data from the system-processing module (250). A battery (230) powers the device.

The secure programmable communicator has a number of interfaces according to the different embodiments of the invention. An LED or light-emitting polymer or light-emitting fibre display and call selection means (310) is connected to the wireless platform module (220). An infrared light port (320) can send and receive data and communicate this to the memory (280) via the wireless platform module (220).

An interface means (400) may comprise suitable interfaces according to the application of the communicator such as interface (120) shown in FIG. 1.

A ring tone generator (330) can generate ring tones to alert the wearer of the device of incoming calls. Alternatively, or in addition, incoming calls can change the images on the display and call selection means (310).

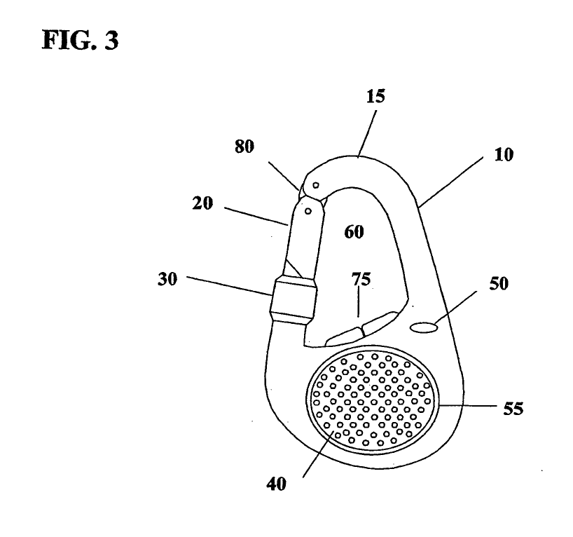

With reference to FIG. 3 is shown an alternative embodiment of the secure programmable communicator in the form of a carabiner clip, wherein the surface comprises a ring fibre display (55) and two call buttons (75). The ring fibre display (55) may comprise several rings of fibre, which can generate light of different colours according to the status of the communicator such as active mode, idle mode, low battery power and such like.

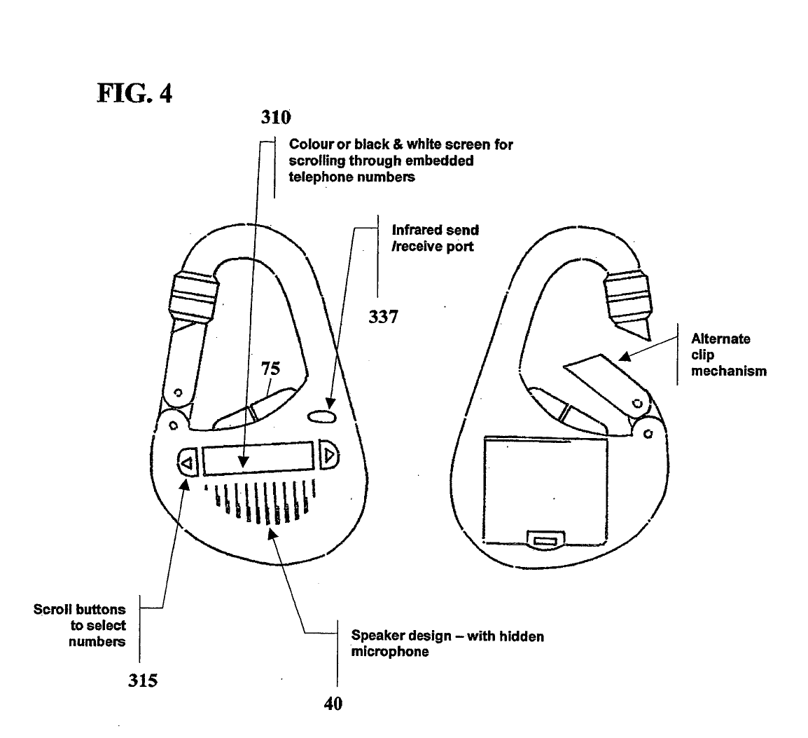

With reference to FIG. 4 is shown a variant of the carabiner clip design for the secure programmable communicator wherein the moveable arm is now in the reverse direction. In addition, the display and call selection means (310) shows two scrolling buttons (315) at either end of the display, wherein the user may scroll through different subscriber numbers by pressing either of the two scroll buttons (315). If the user presses one of the call buttons (75), the secure communicator dials the number shown in the display window.

On the surface of the device is shown an infrared send/receive port (337), which can be used to send image data to and receive image data from local infrared devices.

A key part of the invention is the method, which enables a secure programmable communicator to be purchased in a high street store and activated to be linked to an existing mobile phone subscription. This method is highly suitable to the application of the secure programmable communicator for children and for elderly persons.

The secure programmable communicator contains a SIM card, which is a programmable microcircuit, which is pre-programmed to link it directly to a particular mobile operator. It is proposed that the said communicator could be activated and linked to any existing mobile phone subscription and therefore each would be sold already containing one SIM card, in numbers proportional to the market share of the different mobile operators, thereby making it possible for subscribers from different networks to purchase and activate the device accordingly.

Unlike a normal mobile phone, in one embodiment suitable for children, the communicator cannot receive calls from mobile numbers, which are not stored internally in its memory. In addition, it can only make calls to numbers pre-programmed into its memory. For this reason there is no risk to the operator if the devices have their batteries fully charged and ‘ready-to-go’ in the store since they may not be used unless they are activated.

In the following description the term Child Communicator is used to emphasise the use of the secure programmable communicator as a suitable communications means for children, although the activation method may be equally suitable for SIM card activation for general applications such as in telematics or utility reading where devices contain SIM cards.

In one embodiment of the activation method, the Child Communicator is sold with its subscriber number and SIM ID code on a printed card. The Child Communicator is easily activated when it receives an SMS message containing its own SIM card's unique ID code (often referred to as the PUK code) from a mobile phone sending its own number when calling (a standard user selectable preset). The SMS software verifies the PUK code is correct, identifies the number of the caller, and then programs this into the Child Communicator's own memory now linked to the single key press.

In normal circumstance, for security purposes, the operator generally keeps the knowledge of the PUK code secret from the subscriber and it is only provided when needed to reactivate a locked mobile phone (following 3 successive wrong PIN number entries): Moreover, the PUK number is usually only provided after the identity of the caller has been authenticated. In this way, the misuse of stolen mobile phones is reduced. The situation is different for the Child Communicator since the access and the use of the device is directly linked to an existing mobile phone subscription. Correspondingly the use of the Child Communicator will be automatically charged to the account of the mobile phone, which according to the method of this invention, is used to activate the device. For this reason the storeowner can sell the Child Communicator with the SIM PUK code of the device's SIM card printed on a card and stored within the packaging.

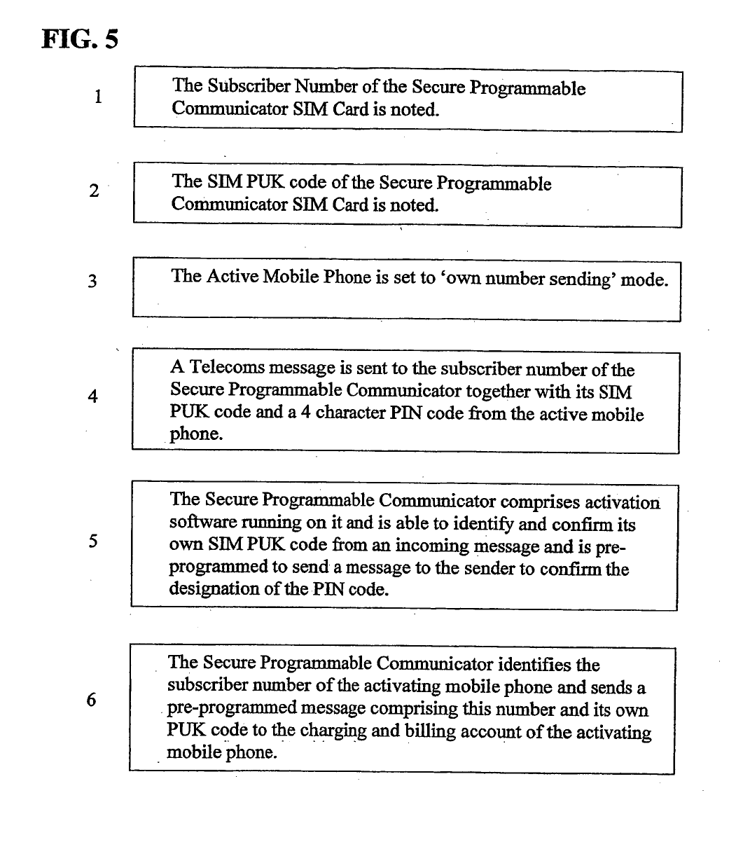

In one embodiment, the plug and play sequence is as follows:
1. Open the packaging and take out the Child Communicator and read its phone number and SIM PUK code.
2. Send an SMS to the Child Communicator's phone number containing only the SIM PUK code and a customer preference PIN separated from the SIM PUK code by a # from the mobile phone whose account will be charged for the calls made by the Child Communicator.
Example: If the Child Communicator phone number is 040 123 4567, and the SIM PUK code is 876543210 and the purchaser's phone number is 0408884444, then the purchaser sends the SMS:
[876543210#1234] to subscriber number 040 123 4567, in own-number sending mode from 0408884444.
3. According to the present invention, in this embodiment, the Child Communicator comprises activation software running on it to identify and confirm its own SIM PUK code from an incoming message and is pre-programmed to send a message to the sender to confirm the designation of the PIN code as 1234.
4. The PIN and or SIM PUK code will be used subsequently to authenticate and prioritise stored subscriber numbers.
5. Consequently, the Child Communicator will identify the calling subscriber number as 0408884444 and send a pre-programmed message comprising this subscriber number of the activating mobile phone, together with the received PUK code as means of authentication, to the charging and billing centre to the operator of mobile subscriber 0408884444.
6. Software at the operator's charging and billing centre will automatically add the Child Communicator's call costs and message costs to the charge account of the activating subscriber, i.e. to the account of 040 8884444.
The activation method described above is shown in FIG. 5.

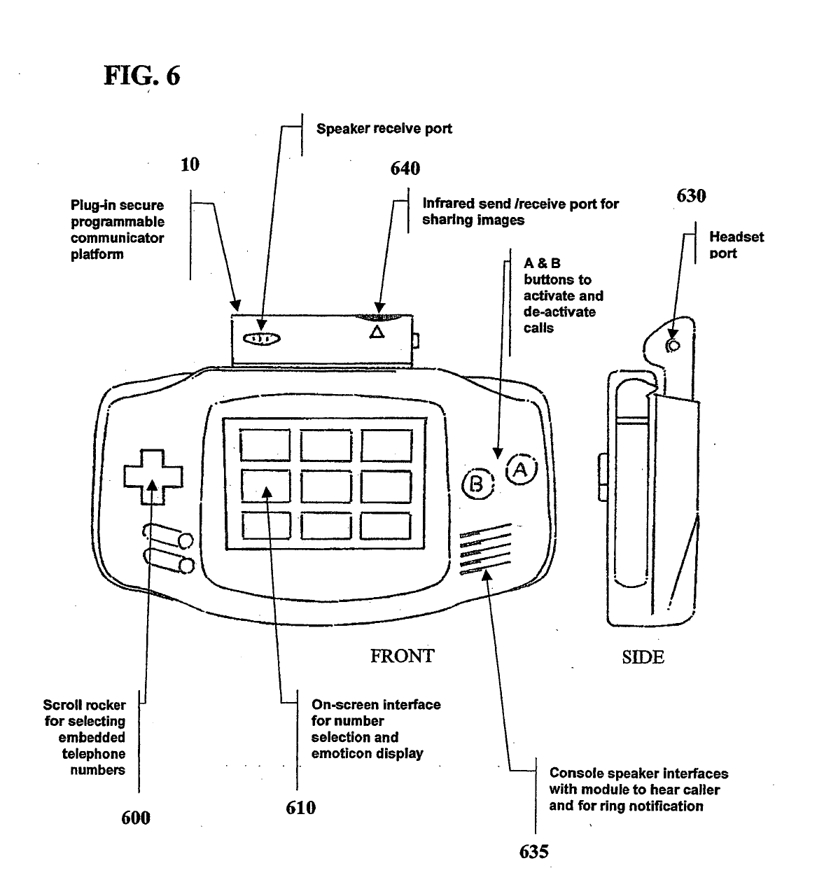

In accordance with another embodiment of the invention, FIG. 6 shows a games console comprising a plug-in secure programmable communicator platform. In this embodiment the plug-in module comprises the capability to dock securely with the games console and may comprise the identical shape as a plug-in games module. In this way the communicator can integrate with the games console and extend the capability of the console to become a fully functional telecommunications device. Furthermore, the added capability makes possible the design and development of new games, which make use of telecommunications messages and GPS position coordinates.

In the same way that games consoles are designed to accept new games cartridges or games modules, the secure programmable communicator platform will preferably slot into an existing port in the console. The input/output port of the communicator is also designed to communicate with the operating system of the games console such that it can make use of the audio-visual display capability already within the console. Additionally, the communicator may make use of the power supply of the console itself.

To enable the games console to communicate via the telecommunications network, the software on the communicator platform generates a subscriber number display (610) on the games console itself, which can be controlled by the games console rocker (600). Buttons A and B can be used to activate and deactivate calls. It is intended that only pre-programmed numbers would be available for the telecoms-enabled console to call.

In a separate embodiment the secure programmable communicator platform may comprise a memory module containing a library of animated or stationary emoticon image elements, and a set of display commands which actively control the movement, colour, hue, size, screen location, and such like characteristics of each emoticon element. By sequentially selecting an emoticon image element and relating this to one or more display commands, the user may make use of the library of elements and set of commands to design a personalised emoticon for the display.

Additional libraries of emoticon image elements may be downloaded via the Internet or received via telecommunications messages or via data calls or via the infrared communications port. In addition, the user may transmit personalised emoticons to other devices or receive emoticon images from other devices using telecommunications messages or via the infrared communications port (640).

Phone calls may be received on the games console by making use of the console loudspeaker (635) and an in-built microphone. Alternatively, a headset port (630) may be used to connect a headset directly to the secure programmable communicator platform.

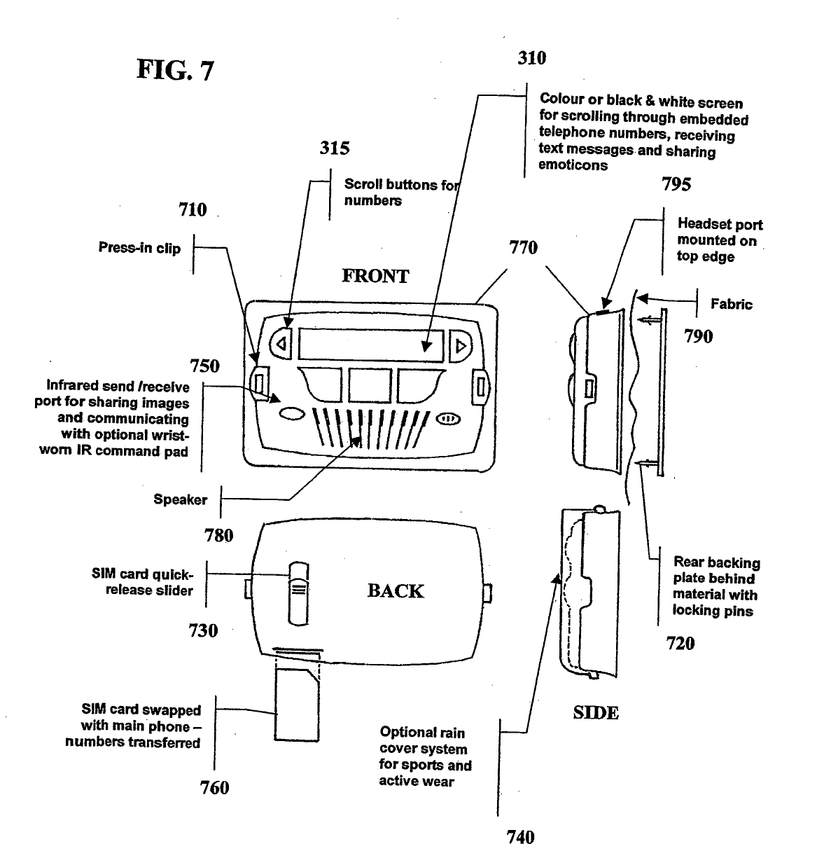

In accordance with another embodiment of the invention, FIG. 7 shows another embodiment of the secure programmable communicator, which can attach to a raised rigid or flexible element (770) wherein said raised element forms part of a surface of a casing or article of clothing or device to which the communicator is to be attached.

In one embodiment, the secure communicator platform comprises the essential telecommunications capability and a display and call-selection means (310) and scroll buttons (315). The said platform is attached to the raised element (770) by way of press-in clips (710). At the rear of the communicator platform is a quick-release slider (730) so that a SIM card (760) can be easily swapped in and out of the communicator platform. It is anticipated that the user may want to put in the SIM card from an existing mobile phone, if a second SIM card is not available.

This embodiment is ideally suited to a person visiting a nightclub who may spend time on the dance floor. The communicator platform is then securely attached to the chest area of a tee shirt, for example, and calls can be made to numbers stored on the SIM card. The communicator platform comprises a small speakerphone (780), which can be used for audio-voice communication. Alternatively, a headset port (795) can be used to plug in a headset.

The raised element (770) may be chemically bonded to the fabric Alternatively, a rear backing plate (720) may be used to sandwich the fabric (790) between the backing plate (720) and raised element (770). The backing plate may comprise protruding pins and or magnetic elements to lock the raised element securely to the article of clothing. Magnets may be preferable if the user wishes a non-permanent means to secure the programmable communicator platform to an article of clothing.

To adapt the programmable secure communicator to outside conditions in the instance that a sports enthusiast would wear it, the secure programmable communicator is provided with a rain cover (740).

With particular emphasis upon fashion and with direction towards the youth culture who enjoy recreational clubbing, the secure programmable communicator platform may comprise a memory module containing a library of animated or stationary emoticon image elements, and a set of display commands which actively control the movement, colour, hue, size, screen location; and such like characteristics of each emoticon element. By sequentially selecting an emoticon image element and relating this to one or more display commands, the user may make use of the library of elements and set of commands to design a personalised emoticon for the display. Additional libraries of emoticon image elements may be downloaded via the Internet or received via telecommunications messages or via data calls or via the infrared communications port. In addition, the user may transmit personalised emoticons to other devices or receive emoticon images from other devices using telecommunications messages or via the infrared communications port (750).

Software modules running on the secure programmable communicator platform may be used to send emoticon images to other communicator devices in the vicinity, wherein these communications may be controlled directly by the wrist-worn control pad.

With reference to all the embodiments described earlier, the present disclosure is for the purpose of illustration only and does not include all modifications or improvements, which may fall within the scope of the appended claims.

1. A programmable communicator (10) comprising a wireless communications platform for communicating via a standard wireless telecommunication network being either GSM (global system for mobile telecommunication) or GPRS (general packet radio service) or CDMA (Code division multiple access) or WCDMA (wide band CDMA) or CDMA2000 or WLAN (wireless LAN) or PDC (Personal Digital Cellular) or via a satellite telecommunications system comprising a secure wireless platform module (220) for processing telecommunication messages and phone calls, an antenna (210), a system processing module (250), a GPS module (260) comprising a baseband correlator means for processing GPS positional coordinates from data received from the antenna (270), a memory module (280) for storing a dedicated operating system and program and status data, a remote device identification list (telephone number list/IP address list), a plurality of processed information and a plurality of GPS coordinates with reference to real-time clock data generated by said system processing module (250), said programmable communicator (10) further comprising a message generation means (240) (short message system, SMS, multimedia message system, MS, enhanced message system, EMS), a rechargeable battery (230), one or a plurality of interface means (400), an LED or light-emitting polymer or plasma screen display or light-emitting fibre display (310) and a call selection means (310) connected to said wireless platform module (220), a ring tone generator (330), a rechargeable battery, said programmable communicator (10) being characterised by:
means for activating as a plug and play device said programmable communicator (10) by receiving one or a plurality of messages (SMS) from a fixed or mobile telephone or wireless LAN device comprising:
(a) the identity module (SIM card) unique ID code (PUK) of said programmable communicator (10) and a customer preference PIN,
(b) a mobile telephone number or subscription identity to which subscription said programmable communicator (10) is to be linked,
(c) the mobile or fixed telephone number or IP address of the authorised programmer, and
said activation means further sending an acknowledgement message (SMS) to the sender, closing the activation phase and putting said programmable communicator (1D) in a programming mode.

2. A programmable communicator (10) as disclosed in claim 1 wherein said programmable communicator (10) further comprising means for authenticating a sender as an authorised programmer wherein said means compares the telephone number or remote device identity (IP address) of said sender with said received authorised programmer telephone number or IP address in said activation phase,
said authorised programmer pre-programming said activated programmable communicator (10) by downloading said remote device identity list (telephone number list/IP address list) by means of one or a plurality of messages (SMS), comprising one or a plurality of mobile telephone numbers or fixed telephone numbers or IP addresses that said programmable communicator (10) can call being the same or different from one or a plurality of mobile or fixed telephone numbers or IP addresses said programmable communicator (10) is allowed to receive calls from, putting said programmable communicator in an operational mode.

3. A programmable communicator (10) as disclosed in claim 2 wherein said programmable communicator (10) is embedded in a rugged protection case in the form of a sports icon wherein said rugged protection case is in the form and shape of a climber's carabiner safety clip comprising an extended fixed arm (15), a movable arm (20) for moving around a spring loaded axis joint (80) to ensure said moveable arm (20) be closed in the rest position providing an empty void (60) with the arms closed, a heat sensor (300) and/or a lock sensor (290), a compartment to enclose said wireless communications platform, a secure locking mechanism (30) comprising a moveable sleeve to lock and unlock said moveable arm (20), a speakerphone (40) for voice and audio communication, a display means (50) indicating the status of said programmable communicator (10) by means of different colours wherein said statuses being active mode and/or idle mode and/or out of base-station coverage area, a call button {70) for calling a preset number and receiving an authorised caller's call, a battery recharge port (110) and a telecommunications port (120) for connecting an audio headset and/or a computer for optionally changing said one or a plurality of mobile or fixed telephone numbers said programmable communicator (10) can call or be allowed to receive calls from.

4. A programmable communicator (10) as disclosed in claim 3 wherein
the surface of said programmable communicator further comprising a ring display (light emitting fibre) (55) and two call buttons (75), and
said ring display (55) comprising a plurality of rings for generating one or a plurality of different colour lights according to said statuses of said programmable communicator (10).

5. A programmable communicator (10) as disclosed in claim 2 wherein said programmable communicator (10) is embedded in a rugged protection case in the form of a-sports icon wherein said rugged protection case is in the form and shape of a climber's carabiner safety clip comprising an extended fixed arm, a movable arm for moving around a spring loaded axis joint to ensure said moveable arm be closed in the rest position providing an empty void with the arms closed, a heat sensor (300) and/or a lock sensor (290), a compartment to enclose said wireless communication platform, a secure locking mechanism comprising a moveable sleeve to lock and unlock said moveable arm, a speakerphone (40) for voice and audio communication, an LED display indicating the status of said programmable communicator (10) by means of different colours wherein said statuses being active mode and/or idle mode and/or out of base-station coverage area, two call buttons (75) for calling a preset number and receiving an authorised caller's call, a battery recharge port and a telecommunications port for connecting an audio headset and/or a computer for optionally changing said one or a plurality of mobile or fixed telephone numbers said programmable communicator (10) can call or be allowed to receive calls from.

6. A programmable communicator (10) as disclosed in claim 3 wherein
said moveable arm (20) makes contact with a sensing element (90), and
said sensing element (90) is supervised by a processing function in order to enable or disable said locking mechanism (30), wherein said processing function being programmed and/or remotely controlled by telecommunications messages (SMS), and said programmable communicator (10) further comprising means for sending an alarm comprising the location and date and time when said locking mechanism is opened by a non-authorised person or accident event.

7. A programmable communicator (10) as disclosed in claim 6 further comprising a display and call selection means (310) and two scroll buttons (315) for scrolling through said stored list of authorised remote device identity numbers (telephone numbers) that said programmable communicator (10) can call, wherein the number the user wishes to dial is selected by scrolling through said list of authorised numbers and pressing the calling button (75) when the number is shown in said display.

8. A programmable communicator (10) as disclosed in claim 2 wherein
said programmable communicator (10) is designed as a plug-in secure module having the shape of a plug-in games module wherein said plug-in secure module docks with a games console by slotting into an existing port in said games console for upgrading said games console, and
said plug-in secure module draws power from the power supply of said games console, and
said programmable communicator (10) comprising an I/O (input/output) port for controlling the display of said games console, wherein said programmable communicator (10) displaying a subscriber number on said games console display (610) and wherein a user scrolls through said list of authorised remote device (telephone) numbers by means of the game console rocker (600) and activates or deactivates calls by means of buttons A and B, and
said game console further comprising a loudspeaker (635), an in-built microphone, and a headset port (630) for receiving a phone call on said game console.

9. A programmable communicator (10) as disclosed in claim 8 further comprising:
an I/O port, and/or an infrared light port (640) through which one said programmable communicator (10) communicates with a second said programmable communicator (10) comprising the same infrared light port for sending an emoticon image and causes said second of said programmable communicators(10) to generate instantly said sent emoticon image on said games console display (310).

10. A programmable communicator (10) as disclosed in claim 2 wherein
said programmable communicator (10) is embedded in a rigid or flexible element (770) being part of the surface of a casing or article of closing or device or machine to which said communicator is to be attached, and
said programmable communicator (10) further comprising a display and call selection means (310) and two scroll buttons (315), and wherein
said programmable communicator (10) being attached to said rigid or flexible element (770) by two or more press-in clips (710), and/or comprising a water resistant cover (740), and
said rigid or flexible element (770) being chemically bonded to the fabric (790) or said rigid or flexible element (770) being attached to a backing plate (720) by means of protruding pins or magnetic elements to lock said programmable communicator (10) to an article of clothing wherein said fabric is sandwiched between said rigid or flexible element (770) and said backing plate (720), and/or
said programmable communicator (10) comprising a small speakerphone (780) and/or a headset port (795) to plug in a headset for use for audio-voice communication, and/or an infrared send/receive port (750) and/or
said programmable communicator (10) further comprising an infrared communication port for transmitting one or a plurality of messages to a wrist-worn IR command pad or to a second similar programmable communicator (10).

11. A programmable communicator (10) as disclosed in claim 8 further comprising
means for storing a library of a plurality of stationary or animated emoticon images including a corresponding alphanumeric code for scrolling through said emoticon images on said display (310) and selecting each of said stationary or animated emoticon images wherein one or more of said plurality of emoticon images of said library being downloaded from the same or from different Internet web pages by one or a plurality of MMS or EMS messages or via GPRS, wherein
said library being changed partially or totally for allowing two or more players to play an interactive game facing each other wherein said programmable communicator (10) sending only the changed features in an emoticon displayed in said interactive game display when a move is made for keeping all of playing game consoles synchronised through said I/O port or infrared light port or by a radiotelephone communication, and further comprising
means to display commands controlling the movement and/or colour and/or hue and/or size and/or screen location of each stationary or animated emoticon element in order to personalise said emoticon display and wherein
an incoming call being automatically linked to said library in order to display one of said stationary or animated emoticon elements in real time according to said permitted callers list of authorised remote device identities (telephone numbers/IP addresses).

12. A programmable communicator (10) as disclosed in claim 6 further
being attached to the clothing of a child for him/her to enjoy playing with said programmable communicator (10) and for supervising adults to track the location of said child, or being attached to a sports person or a field agent to track his location and state, or
being attached to a moveable vehicle in order to protect said moveable vehicle from being stolen or damaged wherein said programmable communicator sending an alarm to a predetermined telephone number stored in said list, or
being attached to a container for monitoring the location and state of said container, or
being locked to the external casing surrounding an inventory article or to an adapted attachment mount for remotely tracking said inventory.

13. A programmable communicator (10) as disclosed in claim 2 further being embedded as an embedded communications platform of a device or machine such as a parking meter or vending machine wherein said display (310) and/or a loudspeaker/speakerphone connected via an interface (400) forms part of the outer casing of the device such that moving and/or still images comprising video and or emoticon images and/or audio files comprising music or news broadcasts or horoscopes (MP3 files) may be downloaded from one or a plurality of web pages or sent by MMS or EMS and played on the device such that images can be shown on the display (310) and audio files can be heard via the loudspeaker/speakerphone.

14. A programmable communicator (10) as disclosed in claim 13 forming part of a device or machine such as a parking meter or vending machine further comprising the capability to generate sounds and/or images in accordance with the operation of the said machine such that music is played via the loudspeaker/speakerphone and/or images are generated on the display when a parking ticket is purchased from the said parking meter or when a drink or a snack or other commodity is purchased from the said vending machine.

15. A method for operating a programmable communicator (10) comprising a wireless communications platform for communicating via a standard wireless telecommunication network being either GSM (global system for mobile telecommunication) or GPRS (general packet radio service) or CDMA (Code division multiple access) or WCDMA (wide band CDMA) or CDMA2000 or WLAN (wireless LAN) or PDC (Personal Digital Cellular) or via a satellite telecommunications system comprising a secure wireless platform module (220) for processing telecommunication messages and phone calls, an antenna (210), a system processing module (250), a GPS module (260) comprising a baseband correlator means for processing GPS positional coordinates from data received from the antenna (270), a memory module (280) for storing a dedicated operating system and program and status data, a remote device identification list (telephone number list/IP address list), a plurality of processed information and a plurality of GPS coordinates with reference to real-time clock data generated by said system processing module (250), said programmable communicator (10) further comprising a message generation means (240) (short message system, SMS, multimedia message system, MMS, enhanced message system, EMS), a rechargeable battery (230), one or a plurality of interface means (400), an LED or light-emitting polymer or plasma display or light-emitting fibre display (310) a call selection means (310) connected to said wireless platform module {220), a ring tone generator (330), a rechargeable battery, said method for operating said programmable communicator (10) being characterised by the steps of:
activating said programmable communicator as a plug and play device (10) by receiving one or a plurality of messages (SMS) from a fixed or mobile telephone or WLAN device comprising:
(a) the identity module (SIM card) unique ID code (PUK) of said programmable communicator (10) and a customer preference PIN,
(b) a mobile telephone number or subscription identity to which subscription said programmable communicator (10) is to be linked,
(c) the mobile or fixed telephone number of the authorised programmer, and
further sending an acknowledgement message (SMS) to the sender, closing the activation phase and putting said programmable communicator (10) in a programming mode.

16. A method for operating a programmable communicator (10) as disclosed in claim 15 further comprising the steps of:
authenticating a sender as an authorised programmer comprising the step of comparing the remote device identity (telephone number/IP address) of said sender with said received authorised programmer remote device identity (telephone number/IP address) in said activation phase, and
pre-programming said activated programmable communicator (10) by downloading said permitted callers list (telephone number list) by means of one or a plurality of messages (SMS), comprising one or a plurality of mobile or fixed telephone numbers or IP addresses that said programmable communicator (10) can call and one or a plurality of mobile and/or fixed telephone numbers and/or IP addresses that said programmable communicator (10) is allowed to receive calls from, putting said programmable communicator in an operational mode.

17. A method for operating a programmable communicator (10) as disclosed in claim 16 further comprising the steps of:
locking said programmable communicator (10) to a person being a child or an adult or an elderly person or to a moveable object being a bicycle or a container or a freight towing or a wagon wherein said programmable communicator being embedded in a rugged protection case in the form and shape of a carabiner safety clip, and
automatically checking the state of said carabiner safety clip, and
sending an alarm to one or more prioritised telephone numbers stored in said list, said alarm comprising the location of said carabiner safety clip, wherein said alarm being provoked by a non-authorised opening of said carabiner clip or by said person when in danger.

18. A method for operating a programmable communicator (10) as disclosed in claim 17 wherein said step of checking the state of said carabiner clip comprising the steps of:
periodically sending a status data including said location of said carabiner safety clip wherein said programmable communicator (10) receiving first one or a plurality of messages (SMS) comprising a period and a command to be executed by said system processing module (250), or
sending when requested by an authorised person, said status data, to one or more prioritised telephone numbers from said list, wherein
said status data comprising the locking state of said carabiner safety clip and/or the status of said battery, and/or a
series of locations and associated dates and times and/or the history of said inventory and/or routing data and/or evaluated time to destination wherein said status data are stored in said memory module (280).

19. A method for operating a programmable communicator (10) as disclosed in claim 16 further comprising the steps of:
displaying a stationary or animated emoticon image from a library stored in said memory module (280) when said programmable communicator (10) receives a call in order to personalise said incoming call, wherein one or more of said plurality of emoticon images of said library being downloaded from the same or from different Internet web pages or by one or a plurality of MMS or EMS messages or via GPRS, wherein said programmable communicator (10) is designed as a plug-in secure module having the shape of a plug-in games module docking with a games console by slotting into an existing port of said games console for upgrading said games console and comprising an input/output port for controlling the display of said games console, and
personalising said emoticon display by controlling the movement and/or colour and/or hue and/or size and/or screen location of each stationary or animated emoticon element from said library.

20. A method for operating a programmable communicator (10) as disclosed in claim 19 further comprising the step of:
changing partially or totally said library for allowing two or more players to play an interactive game facing each other wherein said programmable communicator (10) by sending only the changed features in an emoticon displayed on said interactive games console display when a move is made for keeping one or a plurality of playing games consoles synchronised wherein said console comprising an I/O port, and/or an infrared light port (640) through which one of said programmable communicator (10) communicates with a second of said programmable communicator (10) comprising the same infrared light port for sending an emoticon image and causing said second of said programmable communicator (10) to generate instantly said sent emoticon image changed features on its display (310) through said I/O port or infrared light port or by a radiotelephone communication wherein said interactive game comprising a location characteristic.

21. A method for operating a programmable communicator (10) as disclosed in claim 19 further comprising the step of:
receiving a phone call on said game console wherein said games console further comprising a loudspeaker (635), an in-built microphone, and a headset port (630), and
displaying a telephone number from said list on said game console display (610), and
sending a phone call by scrolling through said list of authorised telephone numbers by means of the games console rocker (600) and activating or deactivating calls by means of button A and B.
